(19) United States
(12) Patent Application Publication
(10) Pub. No.: US 2013/0156520 A1
(43) Pub. Date: Jun. 20, 2013

(54) FINE MACHINING TOOL

(71) Applicants: Michael Hacker, Nurnberg (DE); Rene Schwarznau, Schwarzhofen (DE); Sebastian Kunschir, Nabburg (DE)

(72) Inventors: Michael Hacker, Nurnberg (DE); Rene Schwarznau, Schwarzhofen (DE); Sebastian Kunschir, Nabburg (DE)

(73) Assignee: KENNAMETAL, INC., Latrobe, PA (US)

(21) Appl. No.: 13/643,639

(22) PCT Filed: Mar. 30, 2011
(86) PCT No.: PCT/US2011/030443

§ 371 Date: Feb. 27, 2013

(30) Foreign Application Priority Data
Apr. 27, 2010 (DE) 102010018339.3

(51) Int. Cl. B23D 77/02

(52) U.S. Cl. CPC B23D 77/02
USPC 408/113

(57) ABSTRACT

A reamer having a cylindrical cutter part (1) having a plurality of cutting bodies (4) arranged on the cylinder circumferential surface, the cutting bodies (4) having a cutter region (12) realized as a cutting strip and having a guide region (13) that adjoins the cutter region in a continuous manner in the direction of feed (10).

### BACKGROUND OF THE INVENTION

The invention relates to a fine machining tool for finish machining of bores, namely, a reamer. A reamer that is suitable for the precision production of bores with a high dimensional and surface accuracy is known from WO 2009/030455 A1. This reamer has a cylindrical cutter part comprising a cutting insert and comprising three guide strips distributed over the circumference of the cylinder circumferential surface. With this known reamer, owing to there being only one cutting insert, machining can only be performed at a low feed speed.

Known from WO 2009/0570087 A1, for the purpose of realizing higher feed speeds, is a reamer having a plurality of cutters distributed over the circumference of the likewise cylindrical cutter part. This reamer is suitable for machining at high feed speeds. In fine machining, however, the reamer does not have the desired machining accuracy.

### OBJECT OF THE INVENTION

The invention is therefore based on the object of designing a reamer in such a way that, on the one hand, a high machining accuracy can be achieved and, on the other hand, the tool can be operated at high feed speeds during the finish machining operation.

### ACHIEVEMENT OF THE OBJECT

This object is achieved in an inventive manner by the feature combination of claim 1. The dependent claims contain developments of this invention, of which some are advantageous and some are inventive per se.

The reamer according to the invention has a cylindrical cutter part. The cylinder circumferential surface of the cutter part carries a plurality of cutting bodies arranged in a distributed manner over the cylinder circumferential surface. The invention is based on the fundamental consideration of assigning a combined function to the cutting bodies. Namely, the cutting bodies consist, firstly, of a cutter region realized as a cutting strip. Moreover, the cutting bodies have a guide region that adjoins the cutter region in a continuous manner in the direction of feed. The cutting bodies thus not only perform a cutting function during the stock-removing operation, but at the same time also guide the tool in the bore. Owing to guide elements being arranged in the guide region, the concentricity characteristics of the multiple-cutter tool are improved significantly.

In an advantageous design, the cutter part has a plurality of chip flutes preferably formed into the cutter part with equal spacing. The cutting bodies are arranged in the chip flutes, at the edge thereof. The cutting bodies in this case can run either in the manner of a straight toothing, parallelwise in relation to the central longitudinal axis, or in the manner of an oblique toothing, obliquely in relation to the central longitudinal axis of the cutter part.

For the purpose of combining process steps in one tool, for example semifinish and finish machining, it is possible for two or more of the cutting bodies according to the invention also to be connected in series. For this purpose, two or more cutting bodies are arranged in a row in linear alignment with one another and in series in a chip flute.

It is also to be expressly mentioned that the arrangement of the chip flutes and of the cutting bodies arranged in the chip flutes can be distributed both in an equally spaced manner, uniformly over the circumference of the cylindrical cutter part, and in an unequally spaced manner, at differing distances from one another over the cylinder circumferential surface of the cutter part.

In an advantageous design, each cutting strip has a main cutter extending transversely in relation to the central longitudinal axis. This main cutter is complemented by a secondary cutter that, depending on the respective mounting position in the cutter part, runs either in the direction of the central longitudinal axis or obliquely in relation to the central longitudinal axis. The secondary cutter, for its part, has a cutting edge in its front region in the direction of rotation of the cutter part. Located after the cutting edge is a guide land, which serves to stabilize the cutting edge. In a preferred embodiment, this guide land is designed as a circularly ground land. In the case of certain other realizations, the size of the guide land can also be 0 in the cutter region.

In a further design, it is provided that the cutting edge of the secondary cutter is designed such that it tapers in the direction of the central longitudinal axis. Thus, with its cutting edge, the cutting strip tapers continuously from the end face of the cutter part, resulting in a conically shaped tool. The conicity in this case is in a range from 1/100 to 10/100 per 100 mm, in several cases also 0 mm per 100 mm beyond the first mm.

It is particularly advantageous to provide a secondary flank adjoining the secondary cutter. The secondary cutter in this case graduates homogeneously into the secondary flank. The secondary flank, for its part, preferably also graduates homogeneously and continuously into the guide region. It is advantageous for the guide region of the cutting body to be configured as a guide strip. The guide strip preferably has a cylindrical outer circumferential surface.

In a preferred design, the secondary flank is thus arranged between the secondary cutter and the guide strip that carries a cylindrical outer circumferential surface, the transitions from the secondary cutter to the secondary flank and from the secondary flank to the guide strip being realized in a continuous and homogeneous manner. A very exacting tolerance range is to be observed in this case. The difference between the cutting strip and the guide strip is to be limited to a few μm, preferably +/−1 μm. The homogeneous transition between the cutting strip and the guide strip ensures the good guide characteristics of the cutter part during abrasive fine machining of the bore.

In a further advantageous design, it is provided that a respective inlet land is provided in the region of the edges of the guide surface of the guide strip that extend in the axial direction. The inlet land in this case performs the function of a feed funnel for the coolant/lubricant. The inlet land acting as a feed funnel allows a lubricating film to build up between the guide strip, namely, the guide surface of the guide strip, and the inner wall of the bore. Apart from its original cooling and lubricating property, this lubricating film serves to build up a certain hydrostatic pressure between the guide strip and the bore wall. This hydrostatic pressure thus realizes an additional damping property of the lubricating film formed between the guide strip and the bore wall. The lubricating film prevents, or mitigates, the build-up of oscillations and thus acts in the manner of a shock absorber between the cutter part and the inner wall of the bore. The coolant/lubricant can be supplied through the tool in any manner.

Expediently, the cutting bodies are soldered or adhesive-bonded or screwed to the cutter part. Any other usual manner of fixing cutting bodies to cutting heads is also conceivable, e.g. wedge clamping. In a preferred design, the cutting bodies are realized as adjustable, or settable, cutting strips or cutting inserts.

All usual hard metals or cubic boron nitride are suitable as material for the cutting bodies. Also suitable as material are ceramic materials having a metal matrix as a binder, so-called cermet blanks. Polycrystalline diamond, preferably in the form of so-called polycrystalline diamond tips, is also suitable as material. The main cutters and/or the secondary cutters can be fully or partially coated with these materials, or fully or partially provided with corresponding cutting inserts.

### DESCRIPTION OF THE FIGURES

The invention is described further with reference to the exemplary embodiment. In the figures:

FIG. 1 shows, in a side view, a cutter part according to the invention together with a tool shank and a connecting screw before fitting thereof to form a reamer,

FIG. 2 shows an enlarged side view of a cutter part according to the invention,

FIG. 3 shows a top view, according to arrow III in FIG. 2 contrary to the direction of feed, of a cutter part according to the invention,

FIG. 4 shows the cross-section IV-IV in FIG. 2 of a cutter part according to the invention, in the region of the secondary cutter,

FIG. 5 shows the detail representation V according to FIG. 4 of a cutting body according to the invention, in the region of the secondary cutter,

FIG. 6 shows the cross-section VI-VI in FIG. 2 of a cutter part according to the invention, in the region of the guide strip,

FIG. 7 shows the detail representation VII according to FIG. 6 of a cutting body according to the invention, in the region of the guide strip.

### DESCRIPTION OF THE EXEMPLARY EMBODIMENT

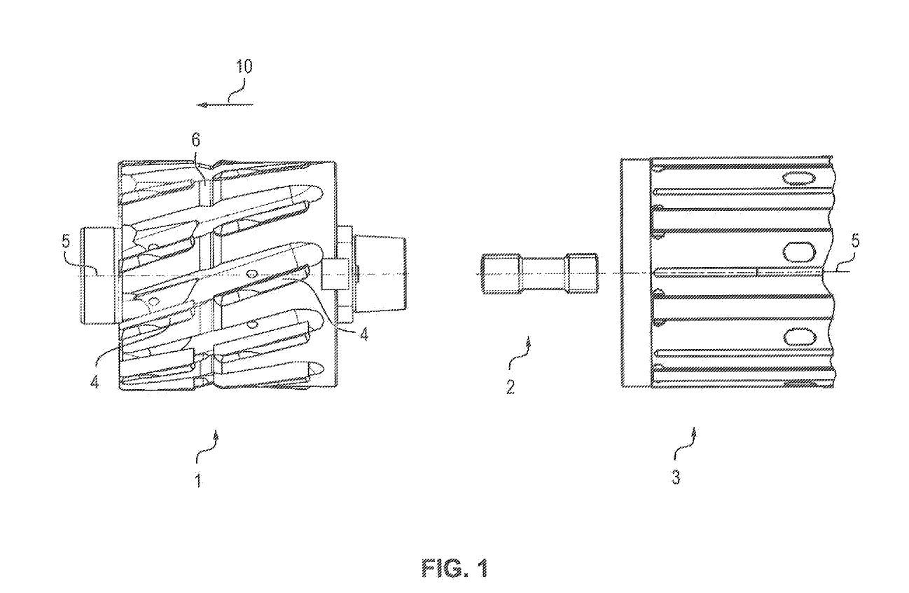

A cylindrical cutter part 1 of a reamer according to the invention is represented in a side view in FIG. 1, which cutter part is made of metal. This cutter part is fastened to a tool shank 3 by means of a screw, preferably a differential screw 2.

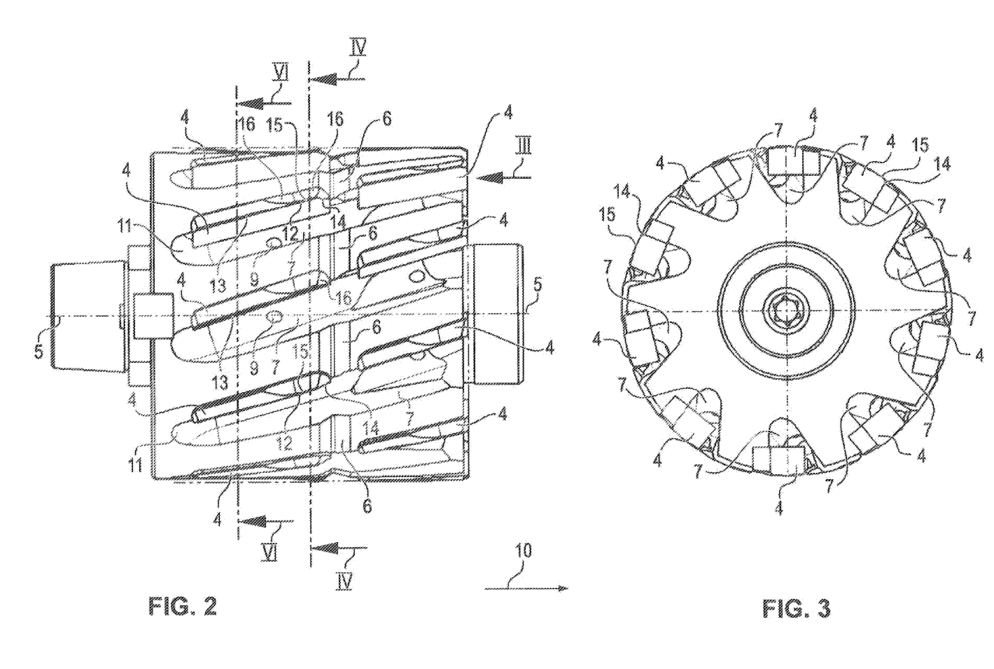

A plurality of strip-shaped cutting bodies 4 made of hard metal are attached to the cutter part 1 shown in an enlarged representation in FIG. 2. Each two cutting bodies 4 are arranged in pairs, in linear alignment in series and, in addition, obliquely in relation to the central longitudinal axis 5.

Between the cutting bodies 4 of the cutting-body pair there is a radial recess 6 in the cutter part 1, which recess extends around the cylinder circumferential surface of the cutter part 1 in the manner of an annual groove. By means of this recess 6, all chip flutes 7 are connected to one another in such a way that a cooling lubricant used for lubricating, cooling or damping can be uniformly distributed to the chip flutes 7. Such an oil is supplied via passages 8, which extend in the cutter part 1 and which open into the chip flutes 7 through corresponding openings 9.

The chip flutes 7 themselves are approximately U-shaped in cross-section and are terminated by a rounded-off end region 11. The respective cutting-body pair is arranged at the edge of each chip flute 7, in each case being the upper edge according to FIG. 3.

In the exemplary embodiment shown here, the cutting-body pairs and, accordingly, also the chip flutes 7, are distributed uniformly over the circumference of the cylindrical cutter part 1. FIG. 3 shows a view, contrary to the direction of feed 10, of the cutter part 1, and illustrates the equally spaced distribution. Also shown here in a perspective representation are the chip flutes 7, their shape and the cutting bodies 4 arranged therein.

The identical cutting bodies 4 have two regions that differ fundamentally in their function but, in respect of the geometric form of the cutting bodies 4, graduate into one another in a smooth and homogeneous manner. A cutter region 12, which is at the front in the direction of feed 10, is adjoined in a continuous manner by a guide region 13 located behind it. This smooth transition, which, viewed microscopically, has graduations having a step height of a few μm, allows the cutting bodies 4 to be ground in only one pass during production.

The cutter region 12, for its part, is constituted by a main cutter 14, the transverse cutter, and a secondary cutter 15, which extends in the form of a strip along the axis defined by the alignment line of the respective cutting-body pair. A plurality of chip flanks 16 adjoin the main cutter 14 and the secondary cutter 15.

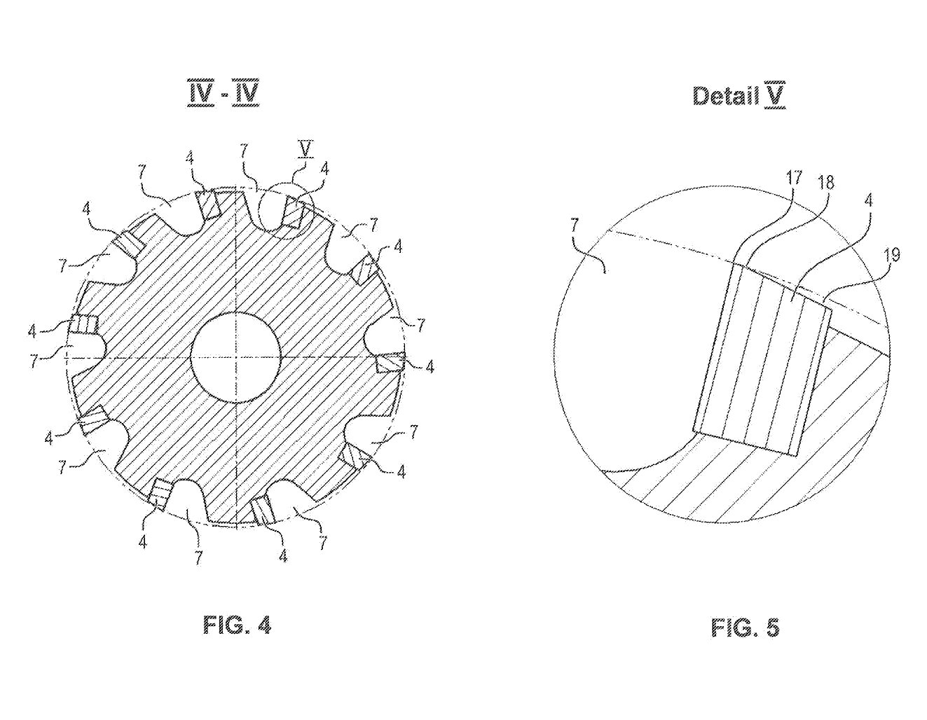

FIG. 4 shows a cross-section of the cutter part 1 according to the invention, at the level of the secondary cutter 15 in the section plane IV-IV in FIG. 2. Shown clearly is the splay of the U-shaped cross-section of each chip flute 7 increasing radially outwards and the cutting bodies 4 projecting radially slightly out of the cylinder circumferential surface of the cutter part 1.

The profile of the secondary cutter 15, which is already indicated in FIG. 4, is additionally represented in an enlarged view in FIG. 5. Here, it can be seen that adjoining a cutting edge 17 of the secondary cutter 15 there is a circularly ground guide land 18, which, for its part, graduates smoothly into a secondary flank 19. The strip-shaped guide region 13 of the cutting body 4 according to the invention, which adjoins the cutter region 12 in a homogeneous manner, consequently likewise extends along the alignment line of the respective cutting-body pair.

FIG. 7 shows a cross-section of the cutter part 1 according to the invention at the level of the guide strip according to the section plane VI-VI in FIG. 2. Shown here are the passages 8 for a line for the coolant/lubricant, which open into the openings 9 in front of the section plane IV-IV in FIG. 2 as viewed in the direction of feed.

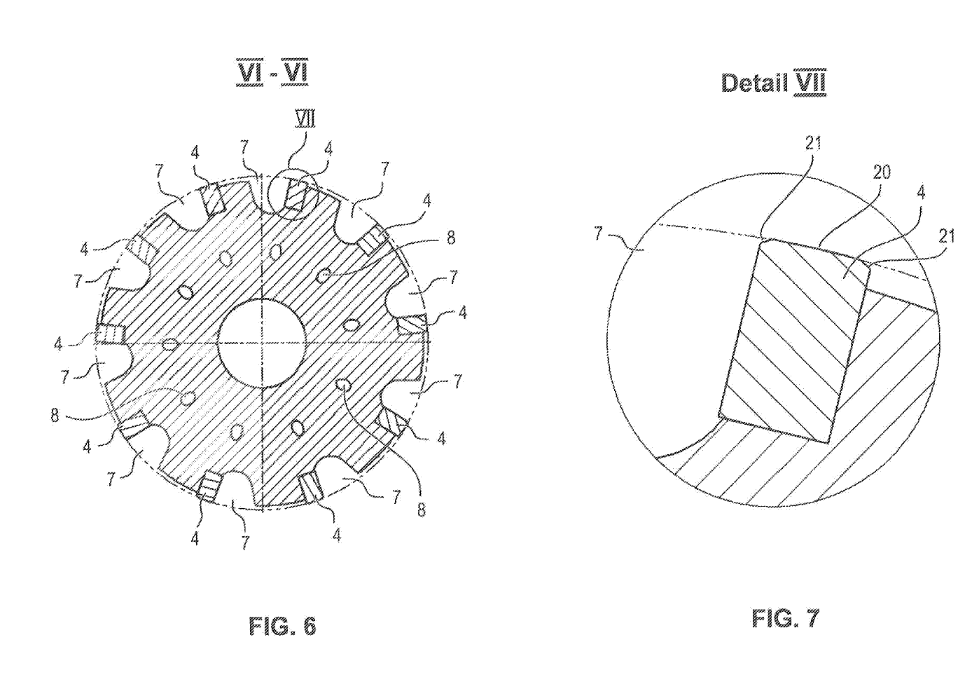

The profile of the guide strip, which is likewise merely indicated in FIG. 6, is again additionally represented in an enlarged view in FIG. 7. For the purpose of adaptation to a cylinder circumferential surface of a bore wall to be machined, the corresponding guide surface 20 of the guide strip likewise has the form of a cylinder circumferential surface having an identical curvature. In the direction of feed 10, the guide surface 20 then graduates homogeneously into the secondary flank 19. In the region of the edges of the guide surface 20 that extend in the axial direction, there is a respective inlet land 21. On the one hand, the guide strip is thereby prevented from being bound to the bore wall by so-called friction soldering points, which usually occur in the outer region of the contact surfaces and, on the other hand, this enables an oil that is used to be pressed between the guide surface 20 and the bore wall according to the principle of a feed funnel.

What is claimed is:

1-10. (canceled)

11. A reamer comprising:
a cylindrical cutter part disposed about a central longitudinal axis and including a plurality of cutting bodies arranged on a circumferential surface thereof, each cutting body of the plurality of cutting bodies having a cutter region realized as a cutting strip and a guide region that adjoins the cutter region in a continuous manner in the direction of feed.

12. The reamer as of claim 11 wherein at least some of the plurality of cutting bodies extend obliquely in relation to the central longitudinal axis of the cutter part.

13. The reamer of claim 11 wherein two or more cutting bodies of the plurality of cutting bodies are arranged in series in a row in a linear alignment.

14. The reamer of claim 11 wherein the cutting strip has a main cutter extending transversely in relation to the central longitudinal axis and has a secondary cutter running in the direction of or obliquely in relation to the central longitudinal axis, wherein, in the direction of rotation of the cutter part, the secondary cutter has a cutting edge in the front region and has a guide land that adjoins the cutting edge and that is preferably circularly ground.

15. The reamer of claim 14 wherein the secondary cutter comprises a cutting edge that tapers in the direction of the central longitudinal axis.

16. The reamer of claim 14 wherein each cutting body comprises a secondary flank adjoining the secondary cutter, such that the secondary cutter graduates homogeneously into the secondary flank and the secondary flank, for its part, graduates continuously into the preferably cylindrical outer circumferential surface of a guide strip that constitutes the guide region of the cutting body.

17. The reamer of claim 11 wherein each cutting body comprises a respective inlet land at the axially extending edges of a guide surface of the guide strip.

18. The reamer of claim 11 wherein the cutting bodies are soldered or adhesive-bonded or screwed to the cutter part.

19. The reamer of claim 11 wherein the cutting bodies are realized as settable cutting inserts or settable cutting strips.

20. The reamer of claim 11 wherein the cutting bodies are composed of hard metal or of cubic boron nitride or of ceramic material having a metal matrix as a binder.
